(19) United States
(12) Patent Application Publication
(10) Pub. No.: US 2009/0268942 A1
(43) Pub. Date: Oct. 29, 2009

(54) Methods and apparatus for detection of motion picture piracy for piracy prevention

(76) Inventor: John D. Price, Corvallis, OR (US)

Correspondence Address: John D. Price, 4670 Rosemarie Place, Corvallis, OR, 97330, US

(21) Appl. No.: 12/322,915

(22) Filed: Feb. 9, 2009

Related U.S. Application Data
(60) Provisional application No. 61/125,232, filed on Apr. 23, 2008.

(51) Int. Cl. G06K 9/00; H04N 5/33

(52) U.S. Cl. 382/103; 348/164; 348/E05.09

(57) ABSTRACT

A copiers' camera or camcorder in a motion-picture audience region is detected by illuminating the audience region with invisible infrared light, and locating any copiers' camera or camcorder within the audience region by imaging the audience region with one or more infrared-light-sensitive cameras. The image captured by the infrared-sensitive camera(s) during a performance may be correlated with information about the audience region, such as row and seat numbers. Copiers may be identified by their presence at seats where copying activity is detected, and the infrared images may be preserved as evidence of the piracy.

### RELATED APPLICATION

This application is related to and claims priority of U.S. Provisional Patent Application Ser. No. 61/125,232, filed Apr. 23, 2008.

### TECHNICAL FIELD

This invention relates generally to detection and prevention of unauthorized copying of motion pictures and unauthorized visual recording of live performances.

### BACKGROUND

The availability to the public of both inexpensive digital storage and high bandwidth enabled by high-speed Internet access has created a need for content producers and media producers to reexamine their business processes in order to try to retain control of the way their products are packaged and distributed. Some producers and distributors of entertainment have been slow to recognize the consumer demand for digitized movies, for example, and have felt threatened by the ease and speed with which entertainment products can be captured, reformatted, repackaged and redistributed. Examples of unauthorized copying and distribution of motion pictures have been widely publicized. Many schemes for “digital rights management” (DRM) have been proposed, and some DRM approaches have been applied to both video tapes and DVDs of motion pictures, for example. However, there is a need for improved detection and prevention of unauthorized copying of commercial movies for unauthorized distribution, both the copying and distribution being commonly characterized as motion picture “piracy.”

### BRIEF DESCRIPTION OF THE DRAWINGS

The features and advantages of the disclosure will readily be appreciated by persons skilled in the art from the following detailed description when read in conjunction with the drawings, wherein:

FIG. 1 is a simplified schematic representation of a theater venue utilizing an embodiment of apparatus made in accordance with the disclosure.

FIG. 2 is a diagram illustrating an embodiment of a method performed in accordance with the disclosure.

FIG. 3 is a simplified schematic representation of a theater venue utilizing another embodiment of apparatus made in accordance with the disclosure.

### DETAILED DESCRIPTION OF EMBODIMENTS

For clarity of the description, the drawings are not drawn to a uniform scale. In particular, vertical and horizontal scales may differ from each other and may vary from one drawing to another. In this regard, directional terminology, such as “top,” “bottom,” “front,” “back,” “leading,” “trailing,” etc., is used with reference to the orientation of the drawing figure(s) being described. Because components of the invention can be positioned in a number of different orientations, the directional terminology is used for purposes of illustration and is in no way limiting.

Throughout this specification and the appended claims, the terms “unauthorized copy” and “unauthorized copying” respectively refer to copies made and to copying performed without permission of a copyright owner, for purposes that go beyond fair use. The term “piracy” is used herein to encompass both unauthorized copying and unauthorized distribution of copyrighted works. The term “camcorder” as used herein refers to any visual recording device that can be used for piracy. The term “imaging” is used herein to denote capture of an image or images, using, for example, a digital camera, a camcorder, or in some cases, a film camera. The term “copier” is used herein to denote a copyist, a person who makes an unauthorized copy. Various forms of the verb “to locate” are used in their customary meanings to refer to determining or indicating the location of something.

### Detection

Most charged-coupled devices (CCDs) and CMOS image sensors used in digital cameras and camcorders are sensitive to some degree to light of infrared wavelengths. This fact is utilized in embodiments described in the following descriptions and drawings.

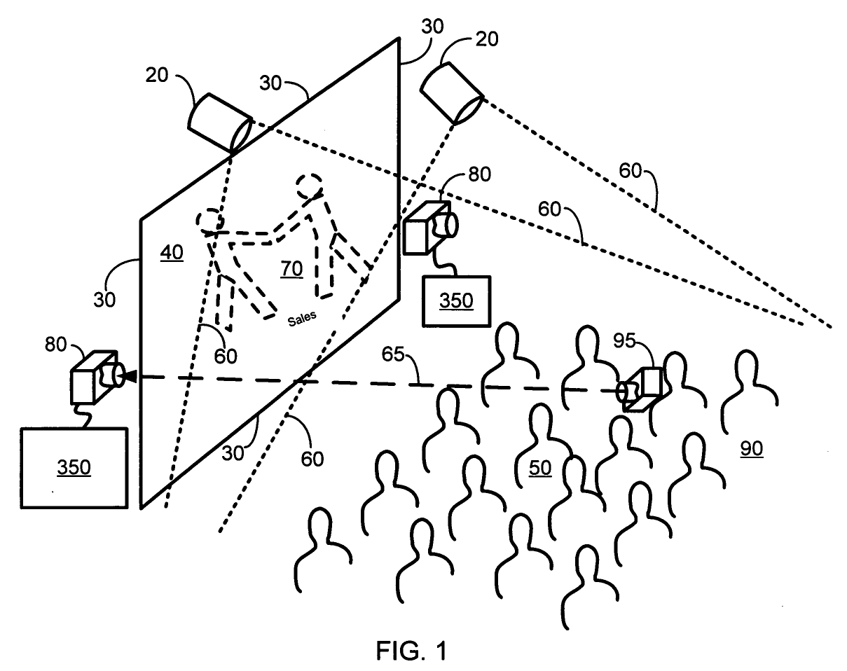

One aspect of the invention provides a method for detecting unauthorized copying of motion pictures. As shown in FIG. 1, at least one infrared illuminator source 20 is disposed near at least one edge 30 of a projection screen 40, generally facing and illuminating an audience 50 with invisible infrared light 60 that does not interfere with the audience's viewing of a motion picture image 70 projected on the projection screen 40. An infrared-sensitive camera 80, facing in the same general direction as the illuminator source 20, is used to image the audience region 90. Such imaging of the audience region 90 may be accomplished with a relatively wide-angle lens, or by panning the audience region 90, or both. The infrared-sensitive camera 80 may include a CCD or CMOS image sensor, for example, and may include a filter to block wavelengths shorter than a selected minimum infrared wavelength. The minimum infrared wavelength may be selected to exclude any visible light.

Infrared illuminator sources are commercially available from Extreme CCTV (a Bosch company) of Vancouver, BC, Canada, Lancaster, Pa., and Fairport, N.Y. (http://www.extremecctv.com/); ANVS, Inc. of North Salt Lake, Utah (http://www.nightvisionweb.com/infrared_illuminators/); and VirtuaVia Ltd. of Grenoble, France (http://www.rayled.com/ir-illuminators.html).

The invisible infrared light 60 will generally reflect from infrared-reflective surfaces (particularly any specularly reflective surfaces) and will be detected by the infrared-sensitive camera 80. Eyeglasses and camera lenses are examples of objects having specularly reflective surfaces. Anti-reflective lens coatings, if present, are generally optimized for visual wavelengths, not infrared wavelengths. Thus, such anti-reflective lens coatings will not interfere significantly with detection of infrared reflections. Eyeglass reflections occur in pairs (generally oriented horizontally) and may exhibit some movement. However, any lens used to record an unauthorized copy of the projected motion picture will perforce be substantially stationary and generally would cause only one isolated reflection. Thus, an analysis of the audience image to detect any isolated single stationary specular infrared reflections can detect any copying camera(s) or camcorder(s) 95 being used for unauthorized copying of the motion picture. Some cameras and camcorders use infrared light beams for an autofocus or range-finding feature, and the infrared-sensitive camera 80 of the embodiment shown in FIG. 1 can also detect infrared light 65 emitted by any infrared autofocus or range-finder beam(s) of any copier's camera or camcorder 95.

Of course, members of the audience 50 also emit infrared radiation by virtue of their body temperatures, but the intensity of infrared from such sources will generally be less that the intensity from specular reflections described above and also less than the intensity from camera autofocus/range-finder sources. Thus the infrared-sensitive camera 80 of the embodiment shown in FIG. 1 can normally distinguish infrared due to attempted piracy by its contrast from the harmless infrared emitted by audience members. The infrared light due to attempted piracy can be distinguished by a simple threshold operation, rejecting image pixels below a selected fixed threshold value of intensity.

However, if such contrast were insufficient, other methods can be employed, such as modulating the infrared illuminator source 20 at a frequency and phase, and synchronously detecting the selected fixed frequency and a related phase in the image signal of infrared-sensitive camera 80. Any infrared light not modulated at the selected fixed frequency is selectively rejected or at least significantly attenuated, thus ensuring sufficient contrast. The synchronous detection may be achieved with a lock-in amplifier, or a circuit incorporating a phase-locked loop, for example. Those skilled in the art of synchronous detection will understand the considerations used in selection of the selected fixed frequency. For example, the selected frequency should not be a multiple or sub-multiple of the local power mains frequency, such as 50 Hz or 60 Hz, and should not be a multiple or sub-multiple of any frequency characterizing the operation of infrared-sensitive camera 80, such as its line scan frequency or its field or frame frequency.

Some available infrared light sources may emit some visible light in addition to infrared light. A filter, such as a Wratten 87C filter, substantially blocking any visible light, may be used on infrared illuminator source 20 if necessary to prevent the audience from visually detecting the source of invisible infrared light 60 and seeing its location. Filters that pass infrared light and substantially block visible light are commercially available, e.g., from LDP LLC of Carlstadt, N.J. (http://www.maxmax.com/axnitefilters.htm), from Edmund Scientific of Barrington, N.J. (http://www.edsci.com), and from other sources.

The image captured by infrared-sensitive camera 80 during a showing or performance may be correlated with information about audience region 90, such as a map of audience region 90 showing row and/or seat numbers. Such a map may be prepared in advance, for example, by preparing a scale drawing of audience region 90 or by photographing audience region 90 (when it is unoccupied) using visible or infrared light and superimposing row and/or seat numbers on the drawing or photograph. If the map of audience region 90 is prepared by photography, the unoccupied audience region 90 is preferably photographed at the same scale from the same camera position as the infrared images from infrared-sensitive camera 80. The map of audience region 90 may be made by photographing the unoccupied audience region 90 with infrared-sensitive camera 80 itself. The two methods of map-drawing and photographing the audience region may be combined, for example by first photographing the unoccupied audience region 90 and then automatically converting the resulting photograph to a drawing, using image-processing methods known to those skilled in the image-processing art.

The correlation of an audience-region map with the image captured by infrared-sensitive camera 80 during a performance may be performed by combining that map and that image in registry with each other, using known methods of image registration and combination. The combination may be performed by averaging or addition of the intensities of corresponding pixels, for example.

Thus, the image captured by the infrared-sensitive camera(s) 80 during a performance may be correlated with information about the audience region 90, such as row and seat numbers. Copiers may be identified by their presence at seats where copying activity is detected, and the infrared images may be preserved as evidence of the piracy.

Infrared-sensitive camera 80 may be a digital camera without an infrared-blocking (anti-IR) filter or a digital camera with an infrared-blocking filter which still allows some amount of infrared radiation to reach the camera's image sensor, such as a CCD or CMOS array sensor. At the time of this specification, the Fuji IS-1 and Fuji IS Pro cameras available from Fuji Photo Film USA, Inc. of Edison, N.J. are examples of commercially available cameras suitable for use without substantial modification as infrared-sensitive camera 80. Other cameras suitable for use as infrared-sensitive camera 80 without substantial modification are the PTZ thermal security series of cameras available from FLIR Systems, Inc. of Wilsonville, Oreg., such as the PTZ-35MS or PTZ-50MS, and the MIC-400 camera available from Bosch Security Systems of Fairport, N.Y. and Bosch Sicherheitssysteme of Stuttgart, Germany.

If a particular digital camera is normally sold with an infrared-blocking filter pre-installed, the infrared-blocking filter may be removed to adapt that camera for use as infrared-sensitive camera 80. The Sigma SD14 camera, commercially available from Sigma Corporation of Aizu, Japan and from Sigma Corporation of America, is an example of a camera whose infrared-blocking filter is fairly easy to remove (see, e.g., http://www.sigmaphoto.com/news/news.asp?nID=3416). Users may wish to note that removing the infrared-blocking filter may void any warranty on a camera.

Removing the infrared-blocking filter removes an optical medium in the light path between the lens and the imaging chip, causing a number of “side effects.” The auto-focus mechanism and any optical viewfinder become un-calibrated. Since the balance of colors arriving at the imaging chip has changed, any auto-color-balance control is no longer calibrated. The back focus position also changes upon removal of the infrared-blocking filter, preventing normal camera lenses from focusing to infinity. Except for the color-balance changes, these side effects can be minimized by replacing the infrared-blocking filter with a suitable clear glass element of substantially the same effective index of refraction. Such a clear glass element also provides a protective cover for the imaging chip.

Camera-modification services are commercially available to modify many off-the-shelf cameras for infrared use. Such modification services are provided, for example, by LDP LLC of Carlstadt, N.J. (whose web site at the time of this specification is http://maxmax.com/IRCameraConversions.htm), Life Pixel Infrared Conversion Services of Mukilteo, Wash. (whose web site at the time of this specification is http://www.lifepixel.com/), and Hap Griffin, Southeastern Laser Center of Sumter, S.C. (whose web site at the time of this specification is http://www.hapg.org/dslrmods.html). Digital cameras that have been modified as infrared-sensitive cameras include, for example, the Canon 60D, 10D, 20D, 30D, 40D, 300D, 350D, 400D and 5D, Fuji S3 Pro, and Fuji S5 Pro, Nikon D1X, D2X, D2H, D100, D40, D40X, D50, D70, D80 and D200, Olympus E-500 and E-510. If necessary, visible light may be blocked from infrared-sensitive camera 80 (while allowing the infrared light to pass through to the image sensor) by using a filter such as a Wratten #87, #87C, #88A, or #89B filter.

Other modifications may also be made on off-the-shelf digital cameras to adapt them specifically for use as infrared-sensitive cameras. For example, autofocus sensors (if present) may be changed to provide accurate autofocus for the infrared wavelengths. However, for use as infrared-sensitive camera 80, such additional modifications may not be necessary.

Image processing for a thresholding operation, and/or for synchronous detection at a modulation frequency, or for other image processing operations that may be employed, may be accomplished with a conventional image processor 350 using known image processing methods. For example, the image processor 350 may be provided in the form of a conventional microprocessor programmed in a conventional manner to perform any desired image processing functions.

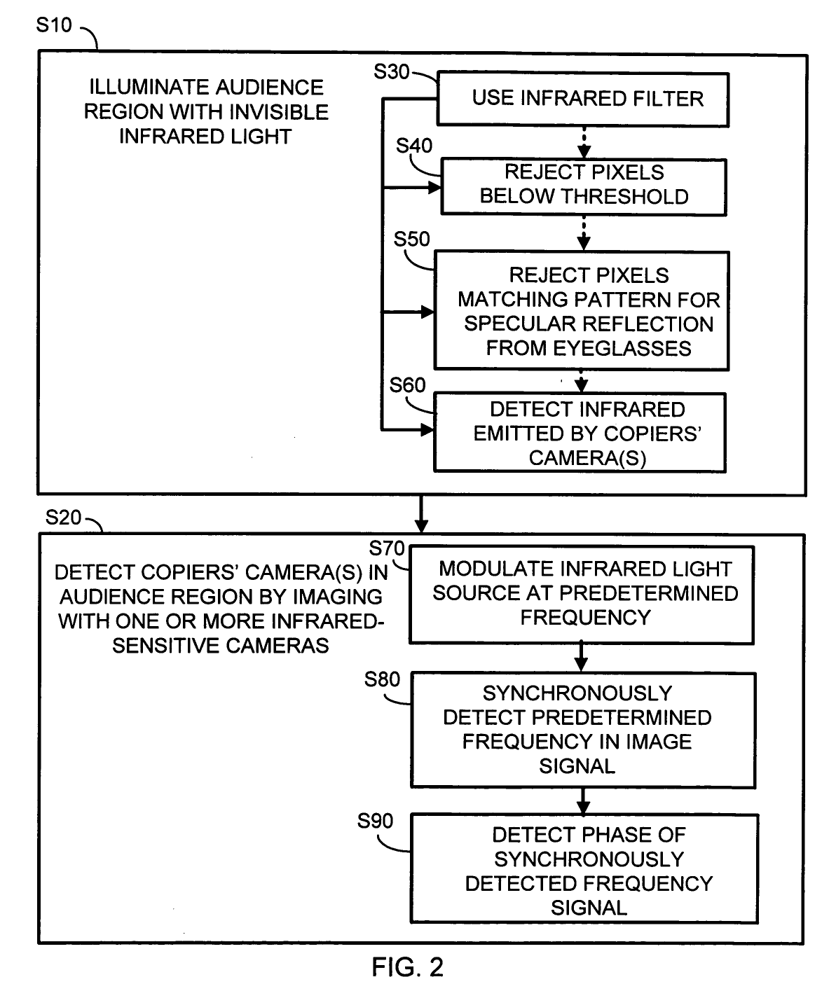

FIG. 2 is a diagram illustrating an embodiment of a method 10, performed in accordance with the disclosure. As shown in FIG. 2, method 10 for detecting a motion-picture copier's camera or camcorder in an audience region may include a step S10 of illuminating the audience region with invisible infrared light, and a step S20 of locating any copiers' camera or camcorder within the audience region by imaging the audience region with one or more infrared-light-sensitive cameras. The method may include a step S30 of imaging the audience region through a filter which passes only infrared light having wavelengths above a selected minimum wavelength. The method may include a step S40 of selectively rejecting pixels whose infrared intensities fall below a selected fixed threshold, e.g., by setting the luminance value of the rejected pixels to a selected constant value, such as a value of zero. The method may also include a step S50 of selectively rejecting sets of pixels whose infrared intensity matches a pattern for specular reflection from eyeglasses by setting the luminance value of the rejected pixels to a selected constant value, such as a value of zero. For example, the pattern for specular reflection from eyeglasses may include a pair of localized infrared maxima disposed substantially horizontally to each other, and the pattern for specular reflection from eyeglasses may include a pair of localized infrared maxima having a common motion. The method embodiment illustrated in FIG. 2 may also include a step S60 of detecting infrared emitted by a copier's camera or camcorder.

Step S10 of illuminating the audience region with invisible infrared light may include a step S70 of modulating the invisible infrared light at a selected frequency. The modulation of the invisible infrared light at a selected frequency may have a selected fixed phase. Step S20 of locating any copiers' camera or camcorder may further include a step S80 of synchronously detecting the selected frequency in the image signal of the infrared-light-sensitive cameras and may include a step S90 of detecting the phase of the synchronously detected selected frequency. If more than one copier were operating camera(s) or camcorder(s) in the audience region, step S20 would be able to detect all such camera(s) and camcorder(s).

Thus, an aspect of the present invention is a method for using infrared radiation, including detecting infrared radiation emitted or reflected from any camera(s) being used by a copier in an audience region for copying projected copyrighted content and correlating a map of the audience region with any infrared emissions associated with each copier. The map of the audience region may have the same scale as the scale of infrared images from one or more infrared-light-sensitive cameras used to detect the infrared radiation from the infrared radiation emitted or reflected from any camera(s). The method also includes locating sites of copying activity, and identifying seats in the map of the audience region corresponding to the copying activity detected, thereby identifying copiers by their presence in those seats where copying activity is detected.

### Alteration of a Recorded Unauthorized Image

This section describes embodiments of methods and apparatus for alteration of any unauthorized image being recorded, for effective prevention of piracy.

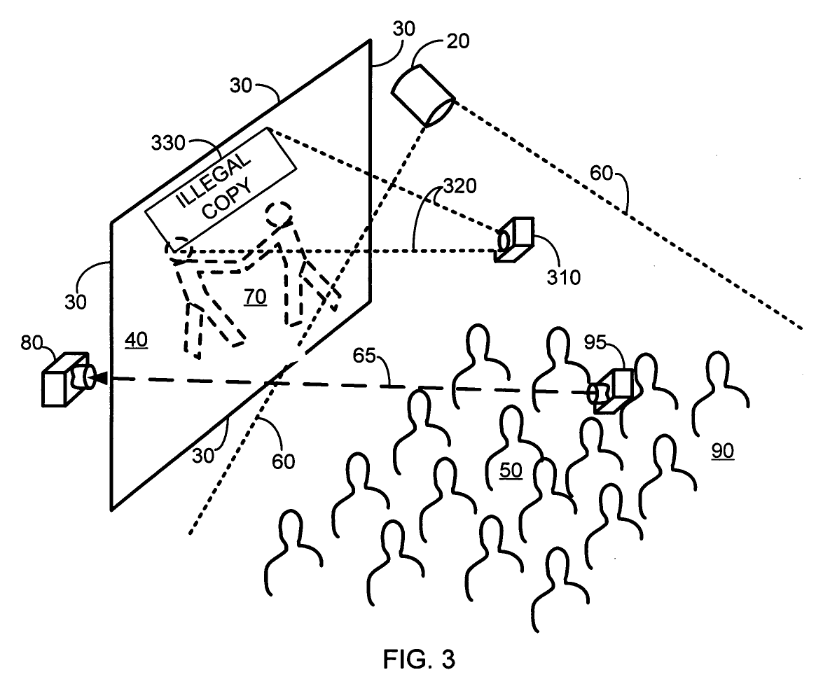

FIG. 3 is a simplified schematic representation of a venue 200 (such as a motion picture theater) utilizing an embodiment of apparatus 300 made in accordance with the disclosure. While FIG. 3 shows a front-projection arrangement for projecting the motion picture, other embodiments may use rear projection of the motion picture. We refer to a projector 210 used to project the motion picture for the audience 50 to view as a “first projector” 210, which normally would project the motion picture images 215 in visible wavelengths of light 220 onto a screen 40. In the embodiment of FIG. 3, a second projector 310 using infrared light 320 may be used to present a piracy-preventive legend 330 on the screen 40. This piracy-preventive legend 330 is superimposed on the visible-light motion picture images 215 of the motion picture, but is invisible to the audience 50. For example, such a piracy-preventive legend 330 may read “ILLEGAL COPY” or “UNAUTHORIZED COPY” or “COPY MADE WITHOUT PERMISSION OF THE COPYRIGHT OWNER.” Because any copier's camera 95 is sensitive to infrared light, the piracy-preventive legend 330 is recorded by any copiers' camera 95, superimposed on the content of the motion picture. The superimposed legend 330, in effect ruins the unauthorized copy, thus preventing effective piracy.

The second projector 310 for presenting a piracy-preventive legend 330 on the screen 40 is depicted in FIG. 3 as an infrared projector, but otherwise second projector 310 has a conventional projector configuration. If second projector 310 comprises refractive optical elements such as a projection lens, such refractive elements are preferably chosen to have little or no absorption of infrared wavelengths. However, in other embodiments, second projector 310 may alternatively be configured as a projector comprising reflective optical elements to avoid any infrared light absorption in refractive optical elements. Or, in other embodiments, second projector 310 may comprise apparatus for scanning an infrared beam 320, such as a scanning infrared laser beam, selectively on the screen 40. Such a scanning infrared beam 320 may be modulated and deflected by known means (e.g., by oscillating mirrors) to generate the characters of the piracy-preventive legend 330 on the screen 40. Projection of piracy-preventive legend 330 onto projection screen 40 may be triggered by detection of a copier's camera or camcorder 95 as described above and illustrated by FIGS. 1 and 2.

The piracy-preventive legend 330 may be varied, for example, being made to move continually around the projection screen 40. By varying characteristics of the piracy-preventive legend 330 in this manner, every frame of an unauthorized recorded image would have piracy-preventive legend 330 in a different portion of the frame. If such a variation were not done and legend 330 were always in the same position, for example, it might be possible to edit piracy-preventive legend 330 out of the unauthorized recorded images, e.g., using automated editing by a computer program. Other effective ways of varying the piracy-preventive legend 330 are described below.

Another aspect of the invention is a method of using infrared radiation. A general version of this method includes (a) detecting infrared radiation emitted or reflected from a camera being used for copying projected copyrighted content, and (b) superimposing a piracy-preventive legend 330 over the projected copyrighted content by projecting the piracy-preventive legend 330 with infrared light. As described above, such a method may include varying visible characteristics of the piracy-preventive legend while performing the step of superimposing. Varying the visible characteristics may be performed, for example, by moving the piracy-preventive legend to various positions in a projected frame, by varying the size of the piracy-preventive legend, by varying one or more fonts of the piracy-preventive legend, by varying layout format of the piracy-preventive legend, and by combinations of those variations. The step of superimposing a piracy-preventive legend 330 over the projected copyrighted content may be performed with a projector comprising refractive optical elements which are substantially transparent to infrared light, or with a projector comprising reflective optical elements which reflect infrared light, or with a modulated scanning infrared beam. The modulated scanning infrared beam may be produced by an infrared laser.

Yet another aspect of the invention combines various features of embodiments described above. Thus, a method for preventing effective copying by any copiers' camera or camcorder 95 of motion picture content 70 projected before an audience region 90 may include illuminating the audience region 90 with invisible infrared light 70, detecting any copiers' camera or camcorder 95 within the audience region by imaging the audience region with one or more infrared-light-sensitive cameras 80, thereby detecting infrared radiation 65 emitted or reflected from any copiers' camera or camcorder, and superimposing a piracy-preventive legend 330 over the projected motion picture content 70 by projecting the piracy-preventive legend 330 with infrared light. Thus, the methods and apparatus of the present invention provide protection of motion picture content with a single layer of detection and a single layer of protection.

Methods and apparatus for alteration of unauthorized images being recorded are also described as “copy mark embedding” in U.S. Pat. No. 7,006,630 to Yu et al., which also uses watermark embedding and watermark detection, thus providing multiple-layer protection.

### INDUSTRIAL APPLICABILITY

Methods performed in accordance with the disclosure and apparatus made in accordance with the disclosure are useful in detecting and preventing unauthorized copying of motion pictures for unauthorized distribution. The image captured by the infrared-sensitive camera(s) during a performance may be correlated with information about the audience region, such as row and seat numbers. Copiers may be identified by their presence at seats where copying activity is detected, and the infrared images may be preserved as evidence of piracy.

Methods performed and apparatus made in accordance with the disclosure do not interfere, either visually or aurally, with the viewing experience of innocent moviegoers. The methods are effective for copiers' camcorders located anywhere in the audience region of a theatre, and are effective for a large number of available camcorders. The methods are effective in the presence of various other electronic devices and do not affect the operation of those other devices. The methods disclosed are not easily circumvented by countermeasures.

Such methods and apparatus may also be used in other security surveillance applications. For example, unauthorized visual (photographic or video) recording of concerts, plays, and other live performances or artistic exhibits may also be detected and/or prevented by adaptations of the methods and apparatus disclosed herein.

Although the foregoing has been a description and illustration of specific embodiments of the invention, various modifications and changes thereto can be made by persons skilled in the art without departing from the scope and spirit of the invention as defined by the following claims. For example, the claimed methods may be applied to slide shows or other sequences of still images as well as to motion pictures. The piracy-preventive legend 330 may be varied in size, font, or layout format, in other characteristics, and/or combinations of characteristics, as well as (or instead of) being moved around in projected frames.

What is claimed is:

1. A method for detecting a motion-picture copier's camera or camcorder in an audience region, the method comprising:
a) illuminating the audience region with invisible infrared light, and
b) locating any copiers' camera or camcorder within the audience region by imaging the audience region with one or more infrared-light-sensitive cameras.

2. The method of claim 1, wherein the step b) of locating any copiers' camera or camcorder within the audience region includes imaging the audience region through a filter which passes only infrared light having wavelengths above a selected minimum wavelength.

3. The method of claim 1, wherein the step b) of locating any copiers' camera or camcorder within the audience region comprises selectively rejecting pixels whose is infrared intensity fall below a selected fixed threshold, by setting the luminance value of the rejected pixels to a constant value.

4. The method of claim 1, wherein the step b) of locating any copiers' camera or camcorder within the audience region comprises selectively rejecting sets of pixels whose infrared intensity matches a pattern for specular reflection from eyeglasses by setting the luminance value of the rejected pixels to a constant value.

5. The method of claim 4, wherein the pattern for specular reflection from eyeglasses includes a pair of localized infrared maxima disposed substantially horizontally to each other.

6. The method of claim 4, wherein the pattern for specular reflection from eyeglasses includes a pair of localized infrared maxima.

7. The method of claim 6, wherein the two localized infrared maxima of a pair of localized infrared maxima have a common motion.

8. The method of claim 1, wherein the step b) of locating any copiers' camera or camcorder within the audience region includes detecting infrared emitted by any copiers' camera or camcorder.

9. The method of claim 1, wherein the step a) of illuminating the audience region with invisible infrared light comprises:
c) modulating the invisible infrared light at a selected frequency.

10. The method of claim 9, wherein the modulation of the invisible infrared light at a selected frequency has a selected fixed phase.

11. The method of claim 9, further comprising:
d) synchronously detecting the selected frequency in the image signal of the one or more infrared-light-sensitive cameras.

12. The method of claim 11, including detecting the phase of the synchronously detected selected frequency.

13. The method of claim 1, wherein the step b) of locating any copiers' camera or camcorder within the audience region comprises correlating a map of the audience region with any infrared emissions associated with each copier.

14. A method for using infrared radiation, comprising:
a) detecting infrared radiation emitted or reflected from any camcorder(s) being used by a copier in an audience region for copying projected copyrighted content, and
b) correlating a map of the audience region with any infrared emissions associated with each copier.

15. The method of claim 14, further comprising:
c) preparing the map of the audience region before performing step b) of correlating.

16. The method of claim 15, wherein preparing the map of the audience region is performed using a method selected from:
i) preparing a scale drawing of the audience region, and
ii) photographing the audience region when it is unoccupied, and
iii) combinations thereof.

17. The method of claim 14, wherein the map of the audience region has the same scale as the scale of infrared images from one or more infrared-light-sensitive cameras used to detect the infrared radiation.

18. The method of claim 14, further comprising:
d) from the infrared radiation emitted or reflected from any camcorder(s), locating sites of copying activity.

19. The method of claim 18, further comprising:
e) in the map of the audience region, identifying seats corresponding to the copying activity detected, thereby identifying copiers by their presence in those seats where copying activity is detected.

20. A method for using infrared radiation, the method comprising:
a) detecting infrared radiation emitted or reflected from any camcorder(s) being used by a copier in an audience region for copying projected copyrighted content;
b) correlating a map of the audience region with any infrared emissions associated with each copier, the map of the audience region having the same scale as the scale of infrared images from one or more infrared-light-sensitive cameras used to detect the infrared radiation;
c) from the infrared radiation emitted or reflected from any camcorder(s), locating sites of copying activity; and
d) in the map of the audience region, identifying seats corresponding to the copying activity detected, thereby identifying copiers by their presence in those seats where copying activity is detected.
